(19) United States
(12) Patent Application Publication
(10) Pub. No.: US 2022/0357971 A1
(43) Pub. Date: Nov. 10, 2022

(54) COMBINED SECURITY AND VIRTUAL INFRASTRUCTURE MANAGEMENT SYSTEM AND RELATED APPLICATION

(71) Applicant: BCD International, Inc., Buffalo Grove, IL (US)

(72) Inventor: Alberto Feliciano, Buffalo Grove, IL (US)

(21) Appl. No.: 17/695,607

(22) Filed: Mar. 15, 2022

Related U.S. Application Data
(60) Provisional application No. 63/184,400, filed on May 5, 2021.

(51) Int. Cl. G06F 9/455

(52) U.S. Cl. CPC G06F 9/45558; G06F 2009/45591; G06F 2009/45587

(57) ABSTRACT

A system which combines security and virtual machine monitoring. Disclosed is an application, in the form of a plugin, that integrates a virtual infrastructure management system with a security system. The application provides a user interface that allows one to simultaneously monitor and manage both systems. The application provides a solution which companies, organizations, etc. can use to manage multiple types of systems effectively from a single point. The solution reduces the knowledge requirement to gain further control of critical and IT infrastructure. As a result, operators at the lowest level can manage and act upon events without the elevated knowledge required of more complex systems.

### RELATED APPLICATION (PRIORITY CLAIM)

The present application claims the benefit of U.S. Provisional Application Ser. No. 63/184,400, filed May 5, 2021, which is hereby incorporated by reference in its entirety.

### BACKGROUND

The present invention generally relates to security systems and virtual machine monitoring, and more specifically relates to a novel and inventive system which effectively combines security and virtual infrastructure management.

Currently, companies and organizations use one set of products and services for virtual infrastructure management (i.e., wherein virtual machines and created and monitored), such as VMware, and a totally different set of products and services to manage security systems (i.e., access control, etc.), such as the Genetec Security Center. Having to use several different products to manage the different areas of responsibility not only requires a high committal of resources, such as personnel, training, and funds, but also results in a complex web of responsibility that is difficult to manage and operate.

Personnel that is trained to monitor and operate a security system do not also run hypervisors (a hypervisor is also known as a virtual machine monitor or VMM, and is software that creates and runs virtual machines (VMs). A hypervisor allows one host computer to support multiple guest VMs by virtually sharing its resources, such as memory and processing.) In other words, security guards are not responsible for running and monitoring virtual machines, and IT personnel is not responsible for monitoring. After all, given the complexity of running and monitoring virtual machines (and the alerts associated therewith), the fact is that the people who are responsible for monitoring and interacting with the security system lack the requisite training.

### SUMMARY

One object of an embodiment of the present invention is to provide a combined security system and virtual machine monitor.

Another object of an embodiment of the present invention is to provide an application that integrates a hypervisor with a security system.

Another object of an embodiment of the present invention is to provide a user interface that allows one to simultaneously monitor and manage both a virtual machine monitor and a security system, thereby effectively combining the two systems.

Still another object of an embodiment of the present invention is to provide a security system that performs virtual machine monitoring (i.e., the virtualization or emulation of one or more computer systems).

Briefly, an embodiment of the present invention provides a solution for companies, organizations, etc. to use to manage multiple types of systems effectively from a single point. The solution is a combined security and virtual machine monitor that reduces the knowledge requirement to gain further control of critical and IT infrastructure. As a result, operators at the lowest level can manage and act upon events without the elevated knowledge required of more complex systems.

### BRIEF DESCRIPTION OF THE DRAWINGS

The organization and manner of the structure and operation of the invention, together with further objects and advantages thereof, may best be understood by reference to the following description taken in connection with the accompanying drawings wherein like reference numerals identify like elements in which:

FIG. 1 provides a block diagram of a system which is in accordance with an embodiment of the present invention, wherein a security system and virtual infrastructure management is combined;

FIG. 2 shows the architecture of the overall system, wherein the system comprises a plugin which is in accordance with an embodiment of the present invention, wherein the plugin integrates multiple systems and provides a single user interface; and

FIGS. 3-9, 10A-10C, 11A-11C, 12A-12E, 13A-13Z, 13AA-13ZZ and 14A-14B are self-explanatory flow charts that relate to the function and operation of the system.

### DESCRIPTION

While this invention may be susceptible to embodiment in different forms, there is shown in the drawings and will be described herein in detail, a specific embodiment with the understanding that the present disclosure is to be considered an exemplification of the principles of the invention and is not intended to limit the invention to that as illustrated.

The availability and maintenance of critical infrastructure are common challenges for organizations. An embodiment of the present invention comprises a plugin which targets critical infrastructure by integrating a virtual machine monitor, such as VMware services, with a security system, such as Genetec's Security Center software.

Preferably, an embodiment of the present invention comprises a full Genetec plugin that integrates with the core Genetec Security Center platform. Preferably, the plugin is built on the Genetec SDK platform, and offers many advantages that are found in the Genetec Security Center such as the creation of entities, Event to Actions, role fail-over, etc.

In the case where the plugin is configured to integrate the Genetec Security Center with VMware services, preferably the plugin is configured to utilize the VMware APIs to integrate VMware services into the Genetec Security Center. Preferably, the plugin is developed on a .NET 4.8 technology stack and vCenter API, version 6.7, and utilizes the VMware APIs to integrate VMware services into the Genetec Security Center. Preferably, the plugin is configured to create virtual machines from templates, manage virtual machine properties, and display virtual machine telemetry.

When the plugin is implemented, administrators can define custom entities with the Config tool as well as health thresholds as deemed necessary. The plugin is preferably configured to utilize custom events as communication between client and server applications and hooks for operators to use with the security center system, such as with the Genetec Security Center or through other management options, such as Genetec Mission Control.

All organizations have the need to monitor, maintain, and react to their critical server infrastructure. Server up time is vital to success in all verticals.

The plugin in accordance with an embodiment of the present invention is configured to provide operators with the agility to make rapid response decisions with real-time notifications and data. The plugin is beneficial to the system administrator in that it provides the system administrator with the capability to manage a system through a “single pane of glass,” meaning that it provides the ability to manage multiple systems and products from a single point, in a single user interface. The plugin provides that administrators have access to real-time VSphere analytics (VSphere is VMware's cloud computing virtualization platform) to monitor their system from anywhere, real-time virtualization events (such as VSphere events) to keep the system synchronized and perform actions when needed, and the ability to create ad hoc virtual machines.

Preferably, the plugin is configured to provide at least the following features and benefits: real-time server telemetry; remote management; virtual infrastructure management and analytics; seamless integration into a comprehensive security system (such as the Genetec Security System platform); and a reduction in the number of systems users need to manage.

To date, there has not been any motivation in the industry to combine a security system with a virtual machine monitor. Both systems are complex and, as a result, in the industry, security guards are security guards and virtual infrastructure management people are skilled IT people. The two systems are kept separate and each system is complex and requires a distinct level of expertise to monitor and interact with each system.

An embodiment of the present invention provides a combined system that effectively combines a security system with a virtual machine monitor, and provides a user interface that is simplified such that a person can easily monitor and operate the combined system.

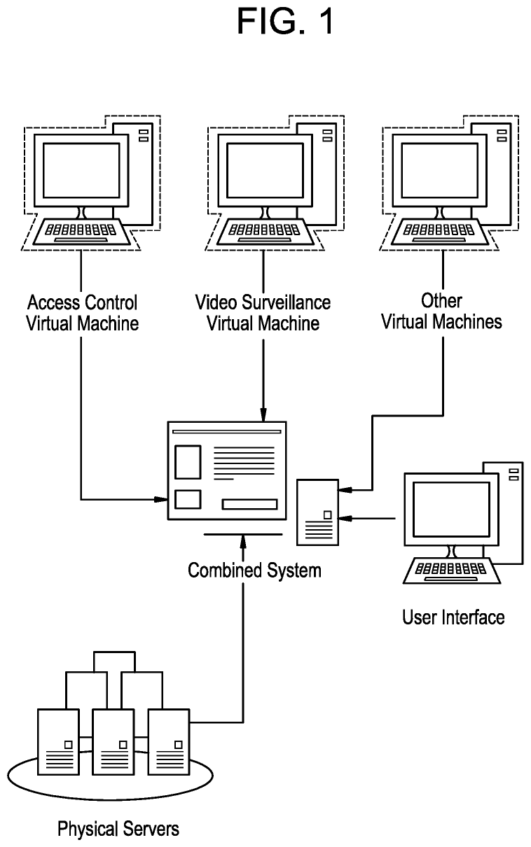

FIG. 1 provides a block diagram of an overall system which is in accordance with an embodiment of the present invention, wherein security and virtual infrastructure management is combined. As shown, a combined system is configured to receive information from a virtual machine monitoring access hardware (such as identification scanners), a virtual machine monitoring video hardware and other virtual machines that can monitor security hardware (such as door sensors, license plate scanners, etc.) typically associated with a security system, as well as receive information from one or more servers and other computer system network hardware typically associated with a server management system. The combined system provides a user interface that displays information related to all connected hardware in a way that is easy to understand, specifically to personnel not specifically and comprehensively trained in IT. As such, the overall system provides a combined security and virtual server management system, presented in a ‘single plane of glass’ via an intuitive user interface.

An embodiment of the present invention provides an application that implements the combination, preferably in the form of a plugin that effectively integrates a hypervisor with a security system, and provides a user interface that allows one to simultaneously monitor and manage the combined system.

Specifically, the virtual machine monitor is preferably VMware's emulator, and preferably an embodiment of the present invention comprises an application in the form of a plugin. The application or plugin is configured to integrate with a security center platform, such as a security center platform that is configured to provide access control, video surveillance, intrusion protection, analytics, communications, as well as possibly also automatic license plate reading. Specifically, the application or plugin may be specifically configured to integrate with a security system, such as the Genetec Security Center platform, which provides all the previously identified functionality (i.e., access control, video surveillance, intrusion protection, analytics, communications, as well as possibly also automatic license plate reading).

The plugin is configured to provide a solution for organizations to operate within a ‘single pane of glass’ (i.e., meaning that it provides the ability to manage other systems and products from a single point). The system provides both virtual machine monitoring or emulation and security center information in a single screen for both monitoring purposes and for taking action. The plugin reduces the knowledge requirement for security personnel to monitor the organization's critical and IT infrastructure. Operators at the lowest level can manage and act upon events without the elevated knowledge required of more complex systems and streamlines communication.

As mentioned above, preferably the plugin is built on the Genetec SDK (Software Development Kit) platform and is configured to leverage many advantages that are found within the Genetec Security Center platform. More specifically, preferably, the plugin utilizes two vast SDK components: the Genetec Security Center SDK and the VMware APIs. Both platforms require a high degree of learning in order to operate effectively and there is an even more vast learning curve to implement their respective programming utilities. The plugin effectively partners with both Genetec and VMware to leverage both technologies in a single solution.

The plugin does not change the core functionality of either Genetec or the VMware virtual monitoring system, but does provide enhancements. The plugin effectively alters the user experience in an IT security setting, and reduces the inundation of data to which end users are exposed on a day to day basis. Operators who, before had to manage multiple systems, gain the capability to monitor and act on both security events and infrastructure events from the same application. Data is passed seamlessly from one application to the other, resulting in a lessening of a burden on IT teams and the overall bottom line.

The plugin effectively provides unified integration between Genetec Security Center and the VMware services. Telemetry and analytics are valuable tools that all organizations struggle to wield to maximum efficiency. The plugin targets critical infrastructure by integrating the VMware systems with Genetec Security Center. Preferably, the plugin is a full Genetec plugin that integrates with the core Security Center platform.

Preferably, the plugin utilizes the VMware APIs to integrate the VMware services into the Genetec Security Center. The plugin is configured to fetch hardware data, system data, and perform analytics that is presented to users in the Security Desk. Additionally, administrators can define custom entities within Config tool as well as health thresholds deemed necessary.

The plugin utilizes Genetec Custom Events as communication between client and server applications as well as hooks for operators to utilize within the Security Center or through other management options such as Genetec Mission Control.

All organizations have the need to monitor, maintain, and react to their critical server infrastructure. Server up time is vital to success in all verticals. The plugin provides operators the agility to utilize virtual machine monitoring or emulation to make rapid response decisions with real-time notifications and data.

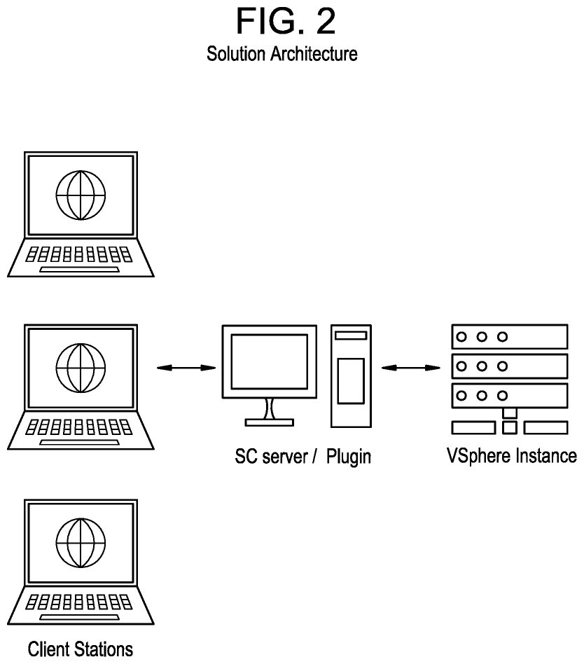

FIG. 2 shows the architecture of the overall system. As shown, an embodiment of the present invention provides a plugin in the Security Center server (i.e., in the middle of the Figure) to allow the Client Stations (i.e., on the left in the Figure) to work with or integrate with not only the Security Center server but also VMware services (i.e., VSphere Instance on the right in FIG. 2), and provides a unified user interface (i.e., a graphic user interface (GUI)) at one or more of the Client Stations), through which a user can use to monitor and manage both systems. For example, the plugin is configured such that alerts relating to both systems come through the user interface, and both systems can be controlled through the user interface. The server in the middle of the Figure is preferably configured to provide security functions, such as access control, video surveillance, intrusion protection, analytics, communications, as well as possibly also automatic license plate reading. As such, from a single client workstation, through a single user interface, a user can monitor and manage both the security system (i.e., run on the Genetec server) and the VMware services (i.e., VSphere Instance).

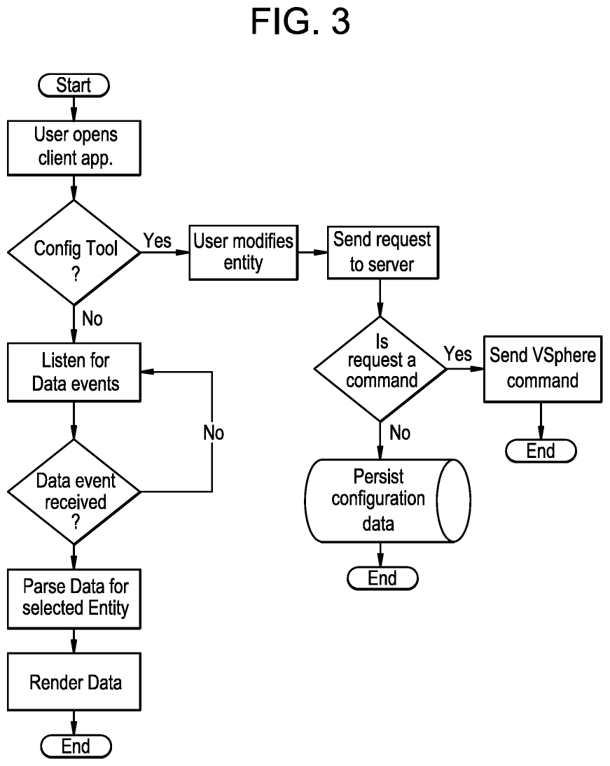

FIGS. 3-9, 10A-10C, 11A-11C, 12A-12E, 13A-13Z, 13AA-13ZZ and 14A-14B are flow charts that are self-explanatory.

Genetec Security Center is comprised of two applications—Config Tool and Security Desk. FIG. 3 shows that when a user opens the Genetec client, the plugin checks to see if the Client is the Config Tool. If it is not, the plugin effectively listens for data events from the Genetec Server. When received, it renders the data into the GUI. On the other hand, if the client is Config Tool, the plugin allows the user to relay commands and configure the virtual machine monitor (such as VMware's VSphere) through the Genetec interface (i.e., through the Security Center platform).

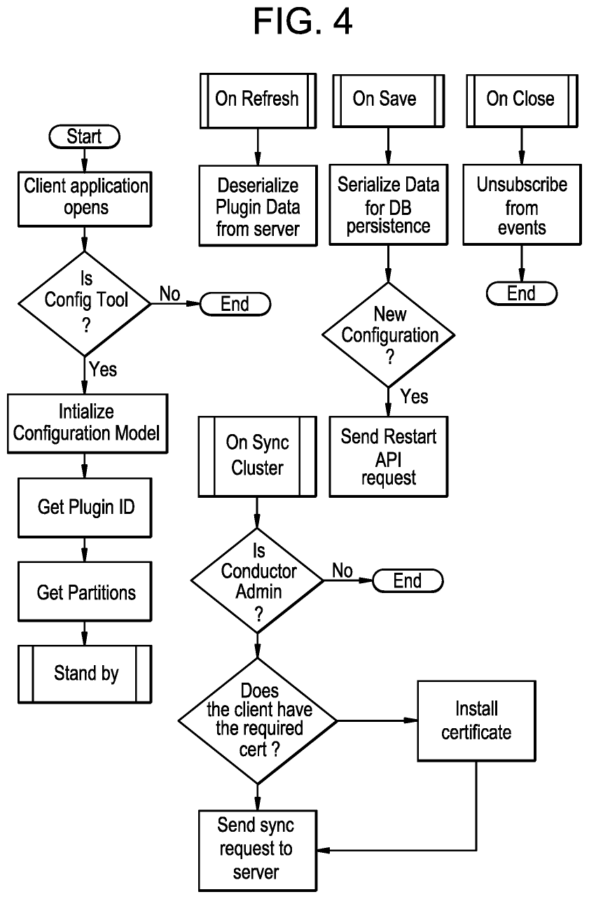

FIG. 4 shows that when a user opens the Genetec Client, the plugin checks to see if the client is Config tool. If it is, the plugin initializes the plugin data model and retrieves the Plugin ID from the Genetec server. It also retrieves any partitions and then awaits user input. When the data model refreshes, data is repopulated from the Genetec server. When the user saves data, the data is serialized as XML into the Genetec database. If there was a new configuration saved, a request is made to the server to restart the VSphere API with the new configurations. When the application closes, any event subscriptions are disposed.

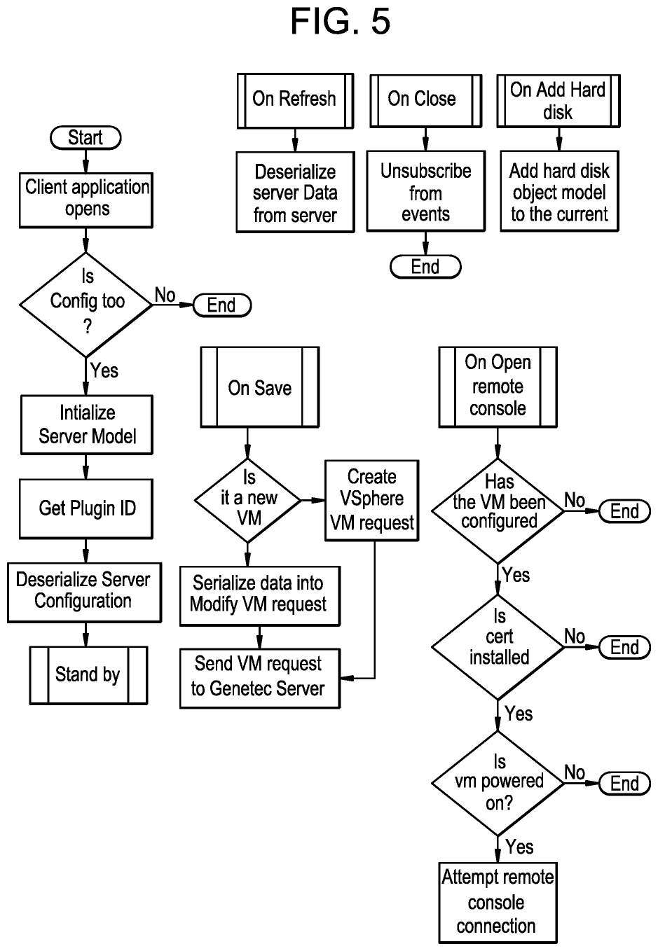

FIG. 5 shows that when a user opens the Genetec Client, the plugin checks to see if the client is Config tool. If it is, the plugin initializes the virtual machine data model and retrieves the Plugin ID from the Genetec server. It also deserializes an object model from the Genetec server. When the data model refreshes, data is repopulated from the Genetec server. When the user saves data, if the VM is new, the plugin creates a new VM request and sends that VSphere through the Genetec Server, otherwise the data is serialized as XML into the Genetec database. When the application closes, any event subscriptions are disposed. When the user configures a new hard disk, an object model is created to be serialized upon saving. When the user requests access into the remote console, it checks to see if the required security certificates are installed and if the VM is powered on before attempting to establish a remote session.

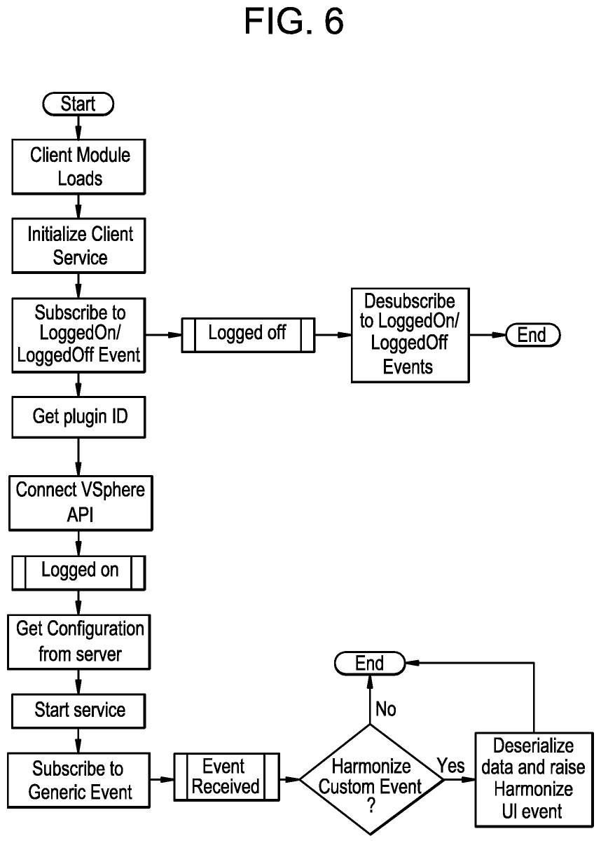

FIG. 6 shows that when the client application starts, the plugin client service initializes by subscribing to the Logged in and Logged off events. When the Logged on event is received, the service gets the plugin configuration from the server and starts the service. A local instance of the VSphere API is initialized. The service listens for any plugin data events and passes them to the Security Desk user interface. When Logged Off, all event subscriptions are disposed.

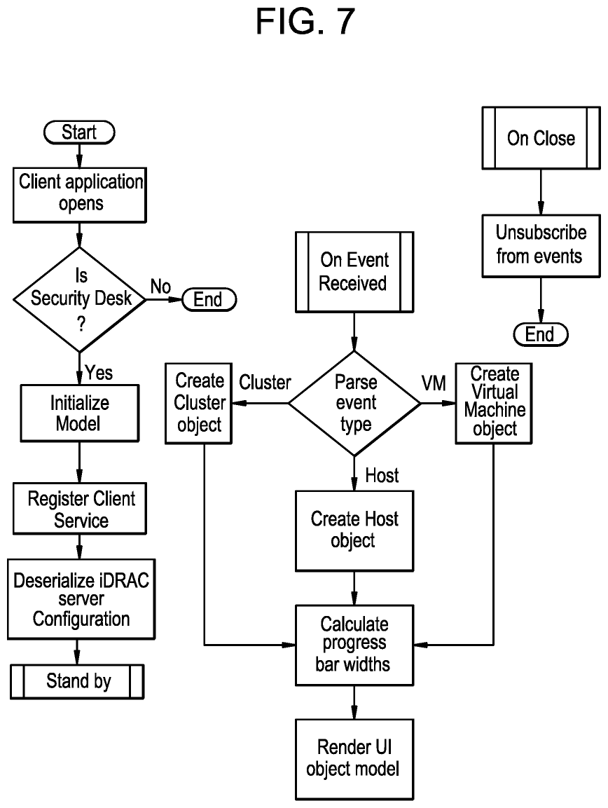

FIG. 7 shows that when a user opens the Genetec Client, the plugin checks to see if the client application is Security Desk. If it is, the plugin initializes the corresponding object data model and retrieves the Plugin ID from the Genetec server. Calculation is performed to render the appropriate widths for the progress bars. It also registers the client service to receive data events and deserializes the plugin server configuration from the Genetec server. When an event is received, a new data model is deserialized to refresh the user interface. The user can view, for example: cluster telemetry data, host telemetry data and virtual machine telemetry data.

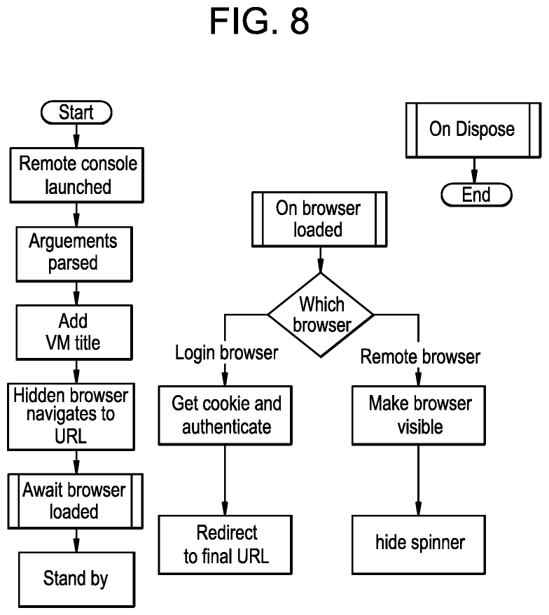

FIG. 8 shows that when the remote console is launched from the client, arguments are passed for initialization. The remote console URL end point is set on a hidden browser. When a browser loads, if it is the hidden login browser, the console retrieves a web cookie, authenticates, and redirects to the final URL. If the remote browser loads, the remote browser is made visible and the Spinner control is hidden.

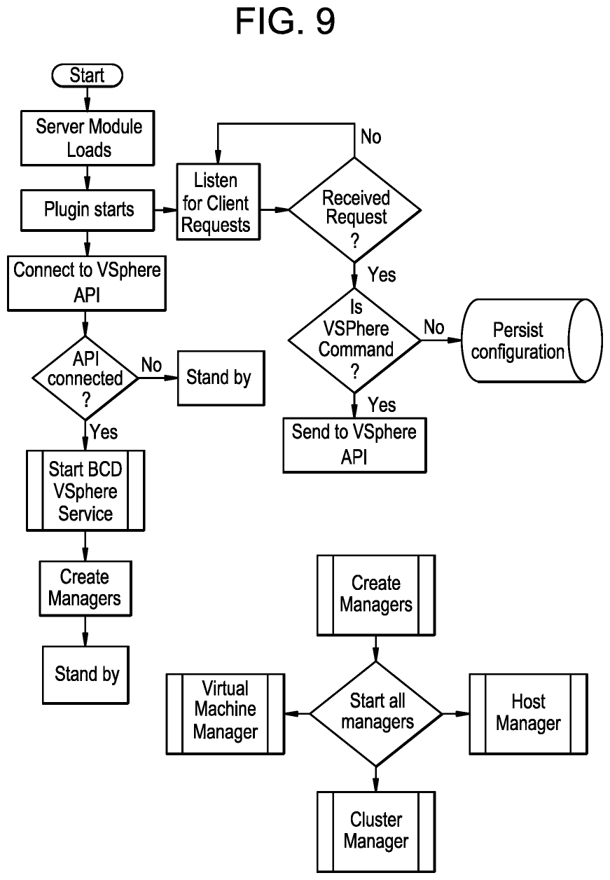

FIG. 9 shows that the plugin server component initializes with the Genetec service. When loaded, a connection to the VSphere API is attempted. If successful, the VSphere service is started and the cluster manager, host manager, and VM manager are created and initialized. The manager is also responsible for handling any commands or requests initiated by users from the Security Desk client.

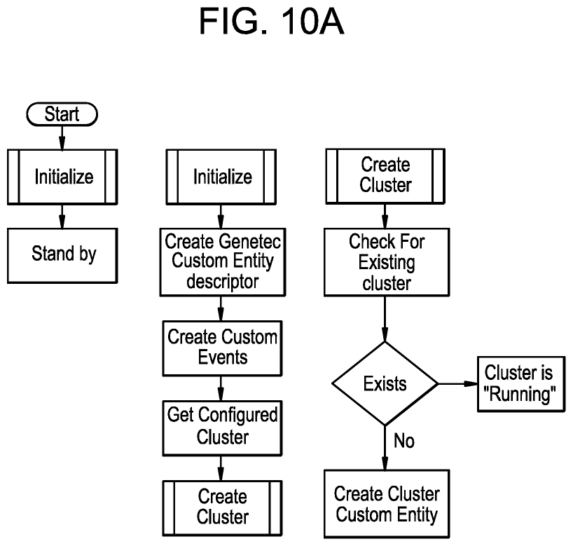

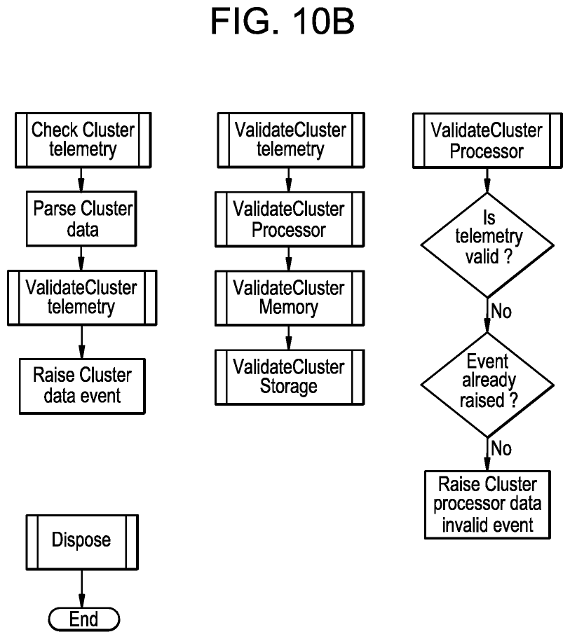

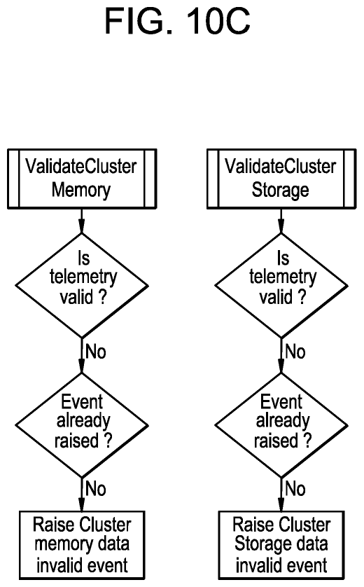

FIGS. 10A-10C collectively show that when the cluster manager initializes, it creates the custom entity type descriptor required to instantiate that type. It creates required custom events and then creates/updates any configured cluster. The manager also parses through a cluster telemetry data (i.e., processor, memory, storage) model to validate against any configured thresholds. If a datapoint breaches a configured threshold, an event is raised.

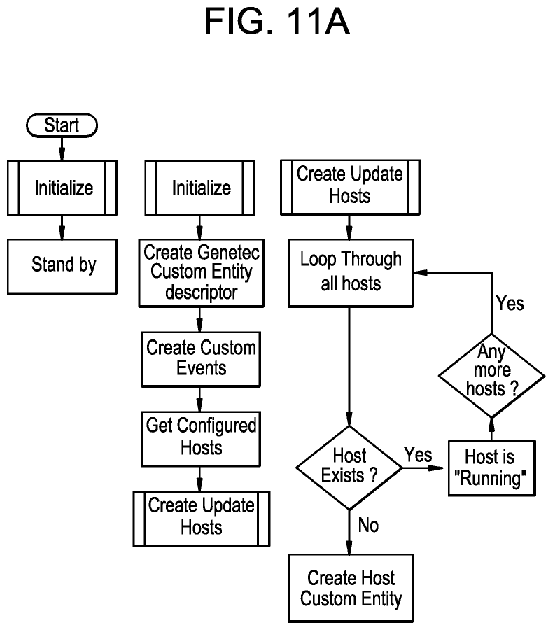

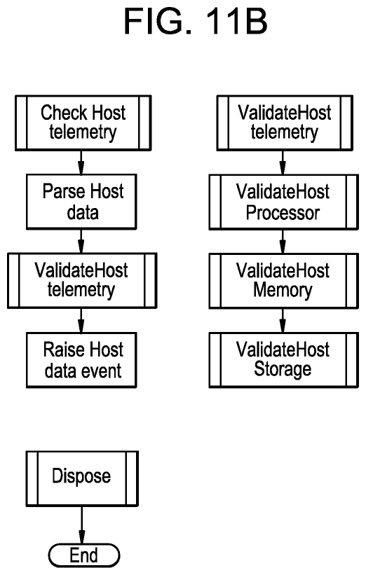

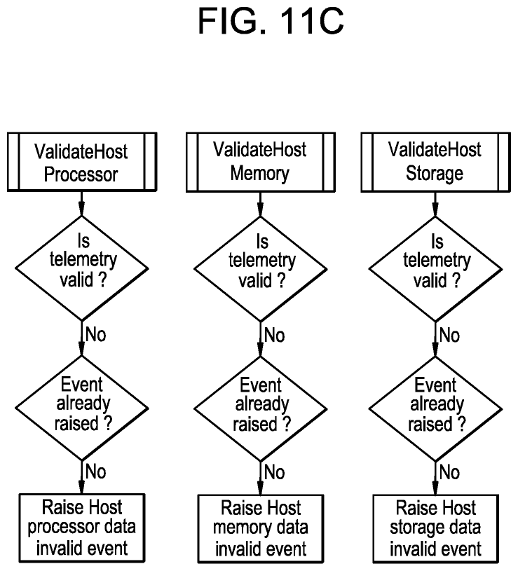

FIGS. 11A-11C collectively show that when the host manager initializes, it creates the Custom Entity Type descriptor required to instantiate that type. It creates required custom events and then creates/updates any configured Hosts. The manager also parses through a host telemetry data (i.e., processor, memory, storage) model to validate against any configured thresholds. If a datapoint breaches a configured threshold, an event is raised.

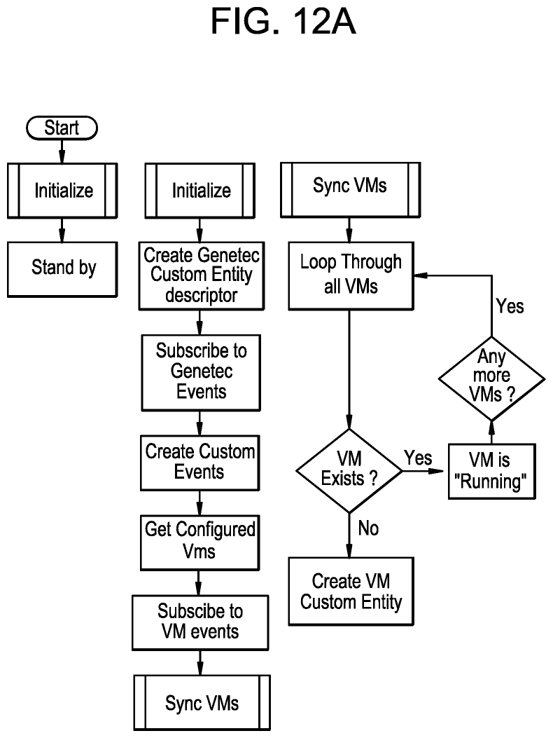

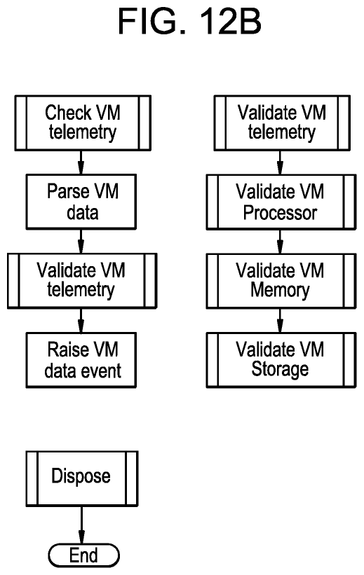

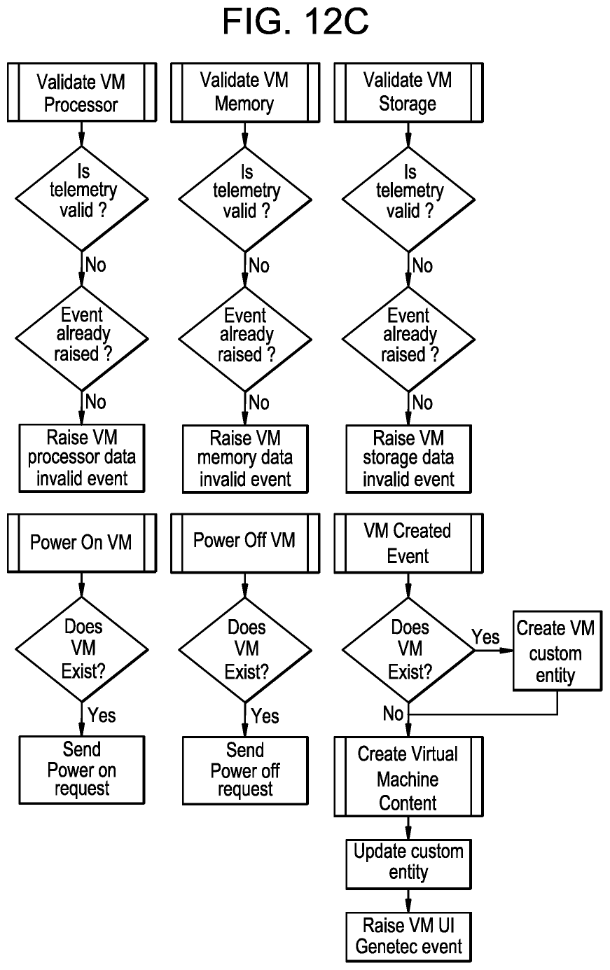

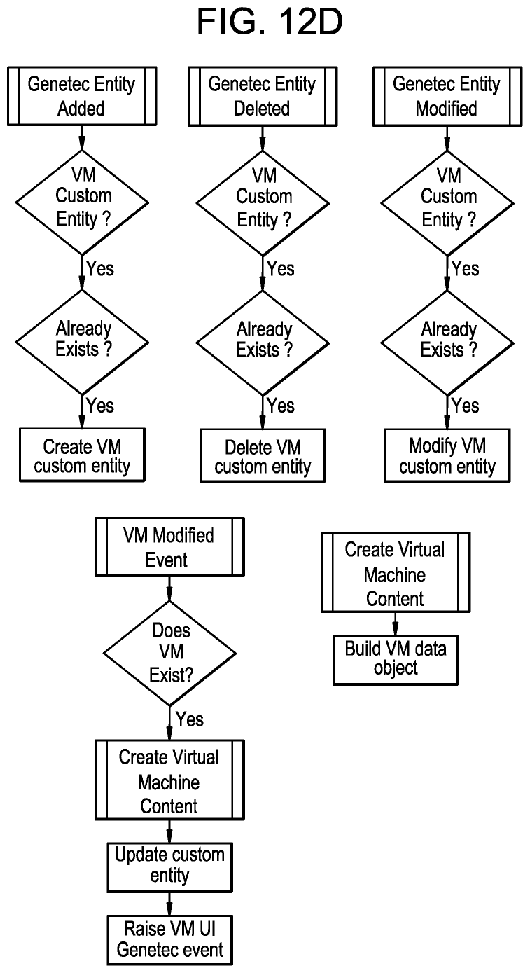

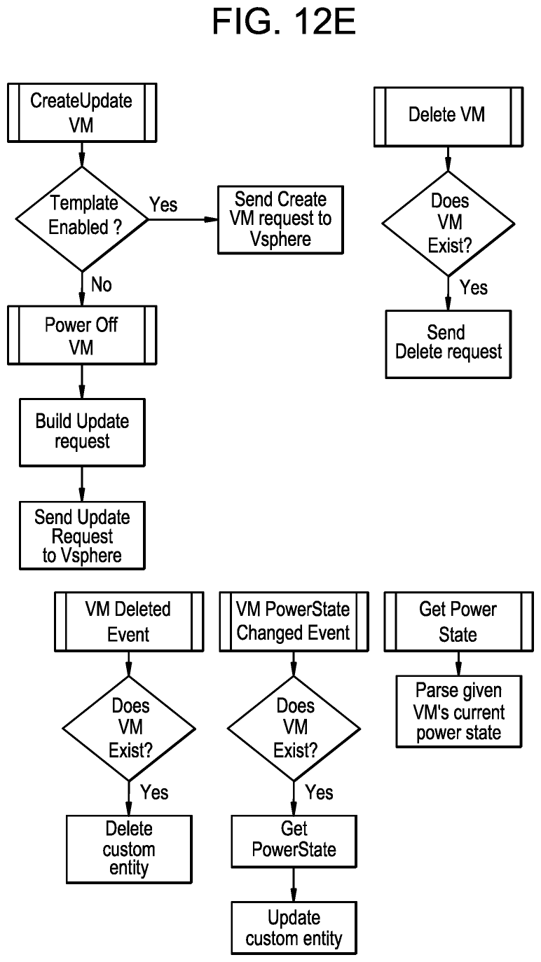

FIGS. 12A-12E collectively show that when the VM Manager initializes, it creates the Custom Entity Type descriptor required to instantiate that type. It creates required custom events and then creates/updates any configured virtual machines. The manager also parses through a VM telemetry data (i.e., processor, memory, storage) model to validate against any configured thresholds. If a datapoint breaches a configured threshold, an event is raised. The manager is configured to power on/off a virtual machine, as well as create requests to VSphere to create/update/delete virtual machines. The VM manager is subscribed to events from the API.

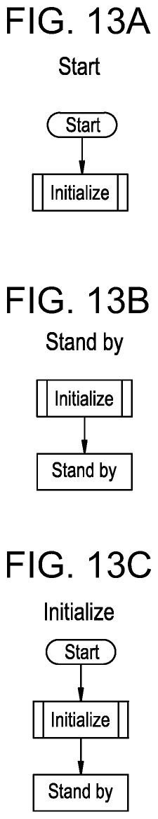

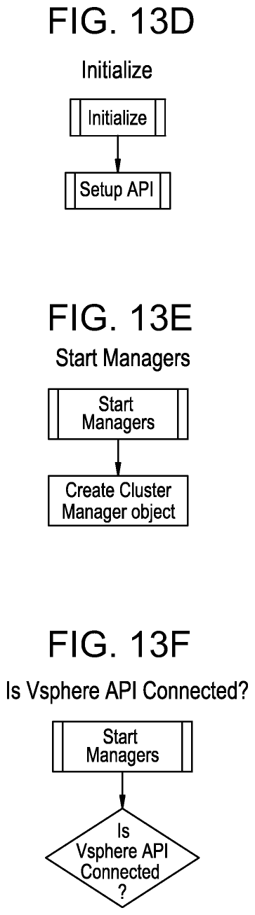

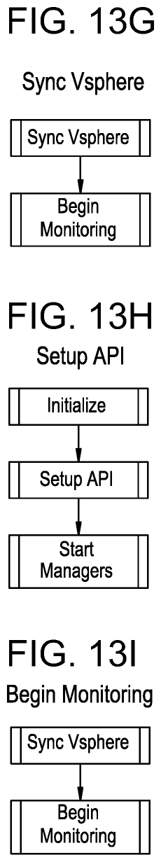

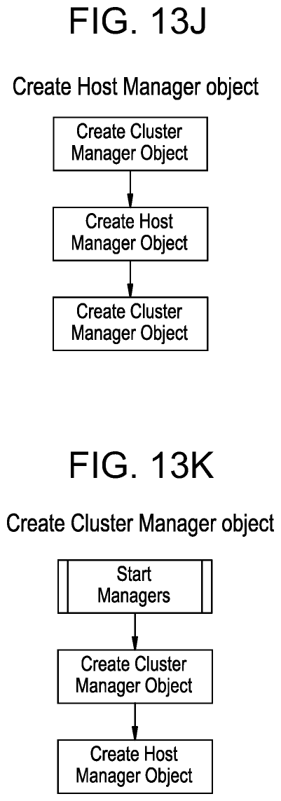

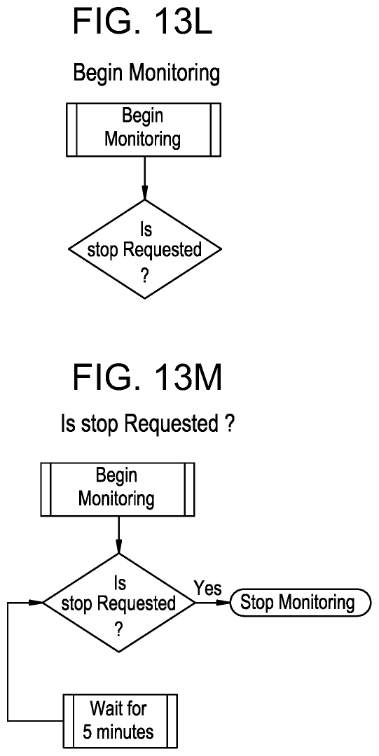

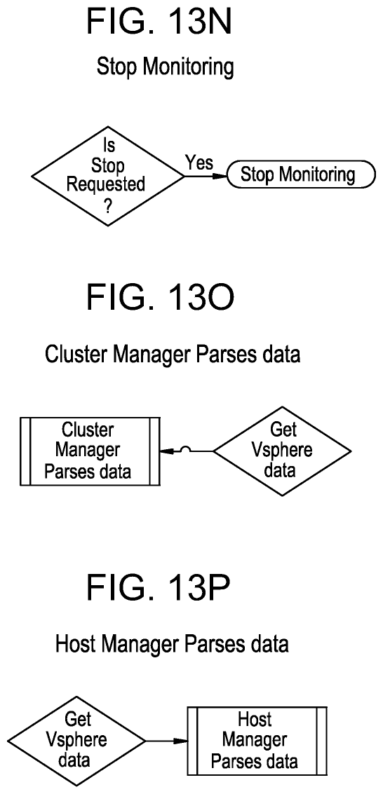

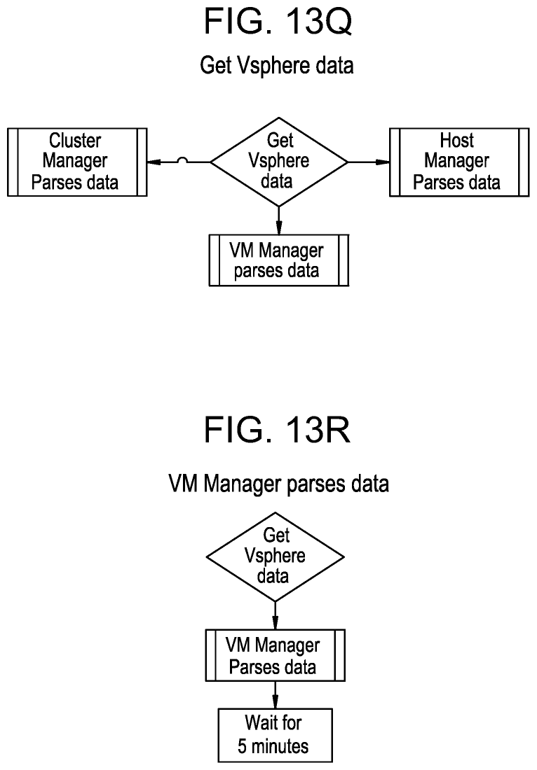

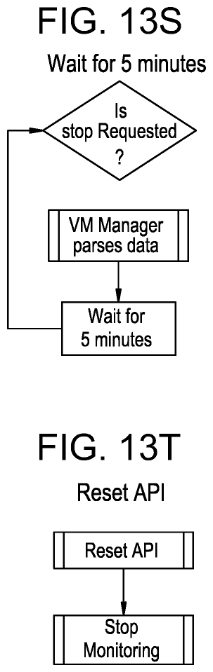

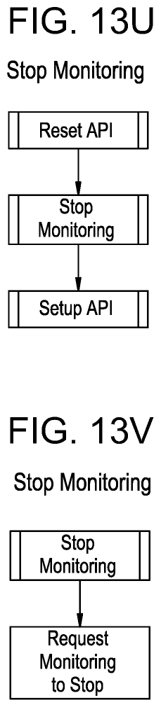

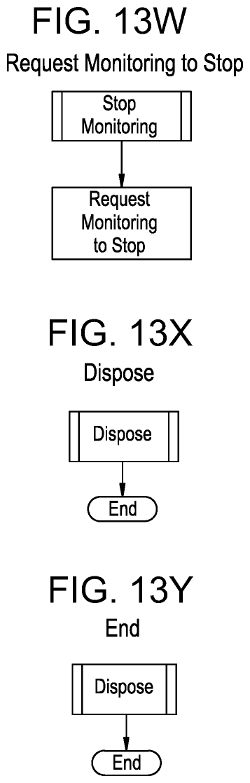

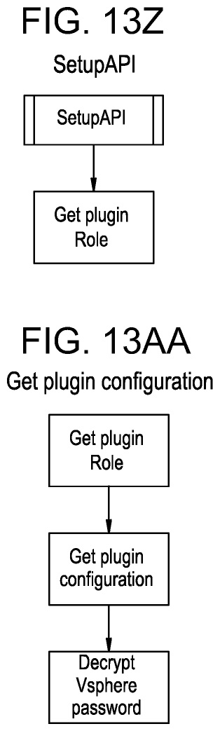

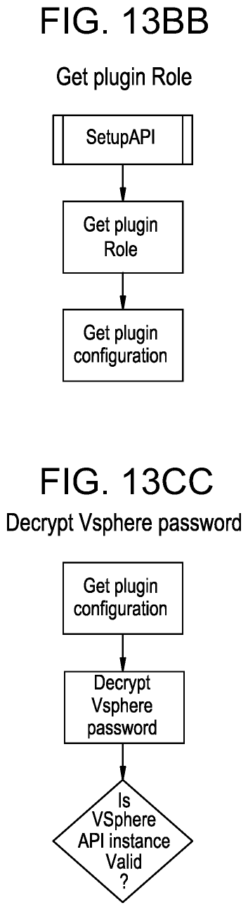

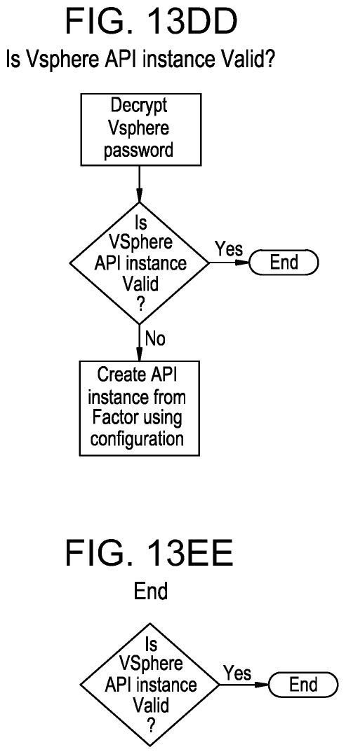

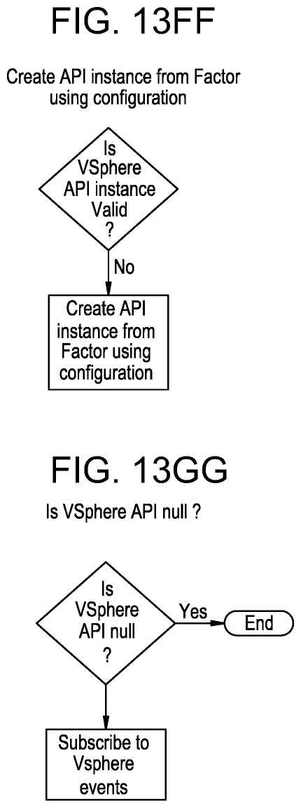

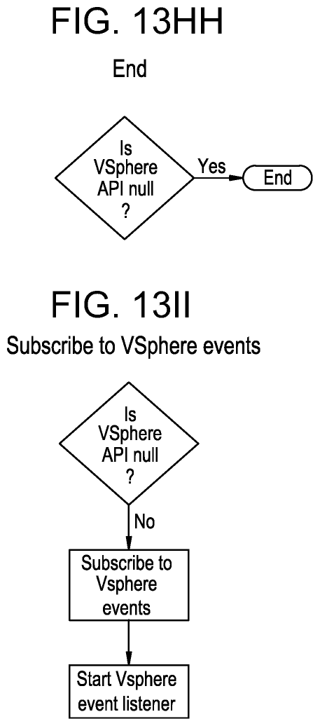

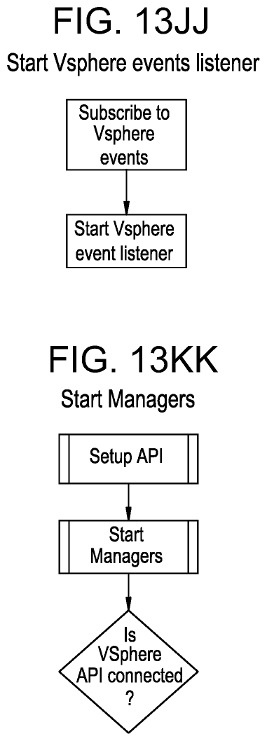

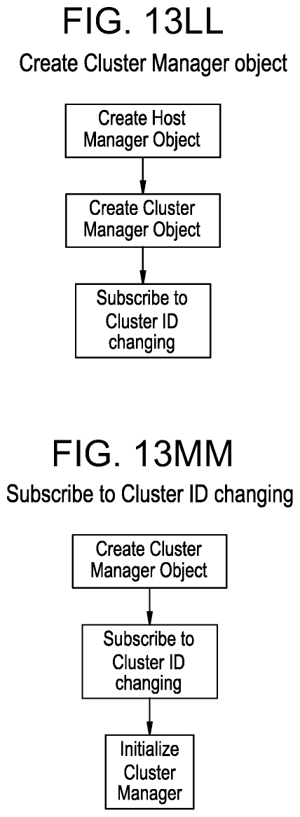

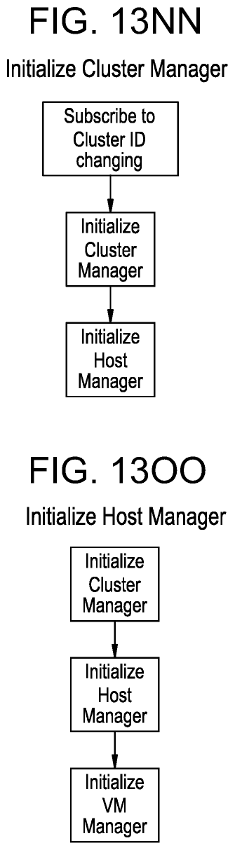

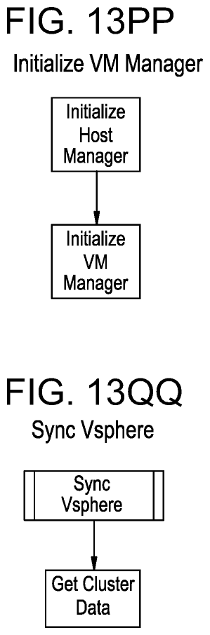

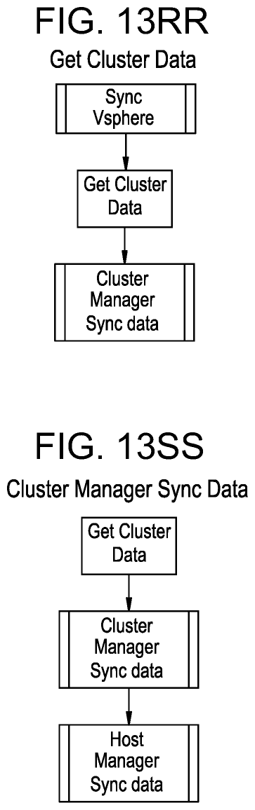

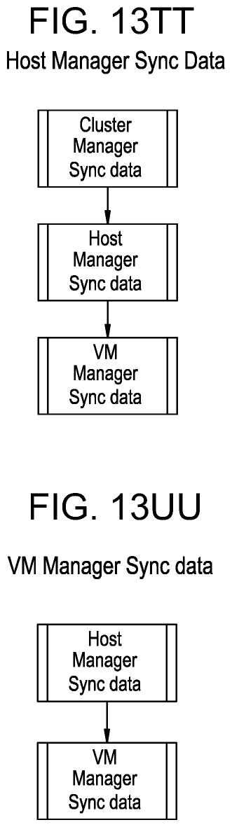

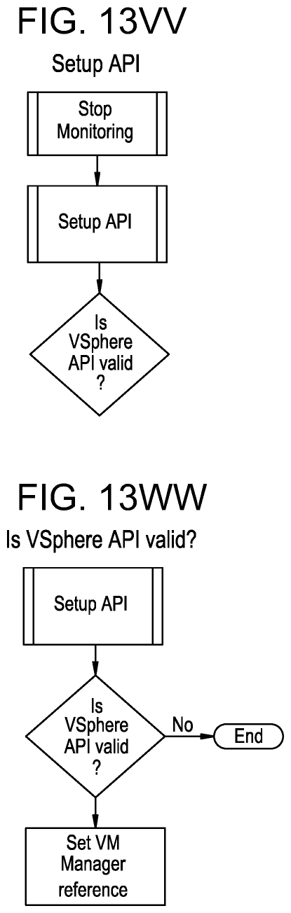

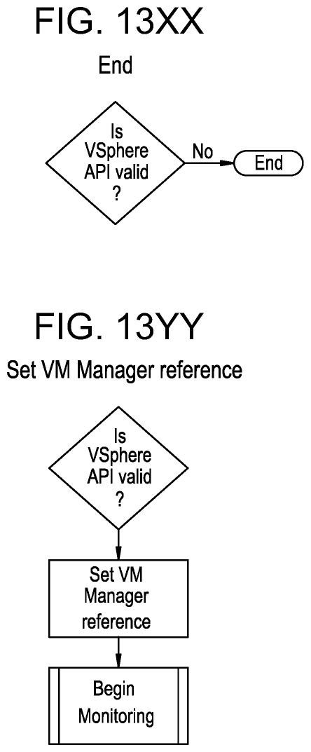

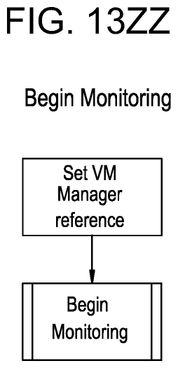

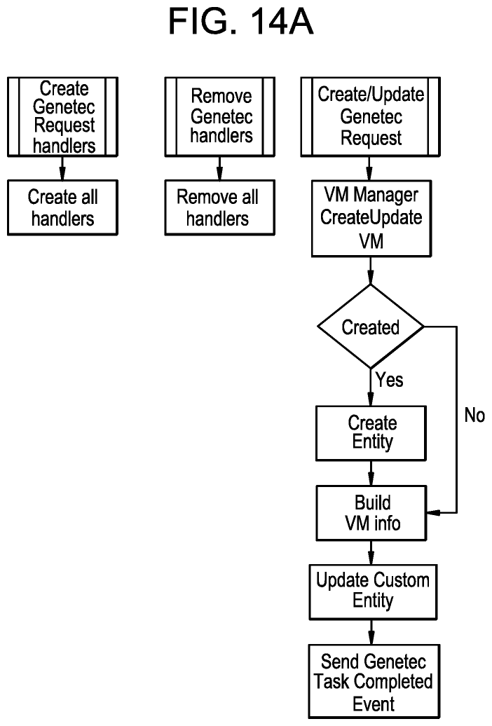

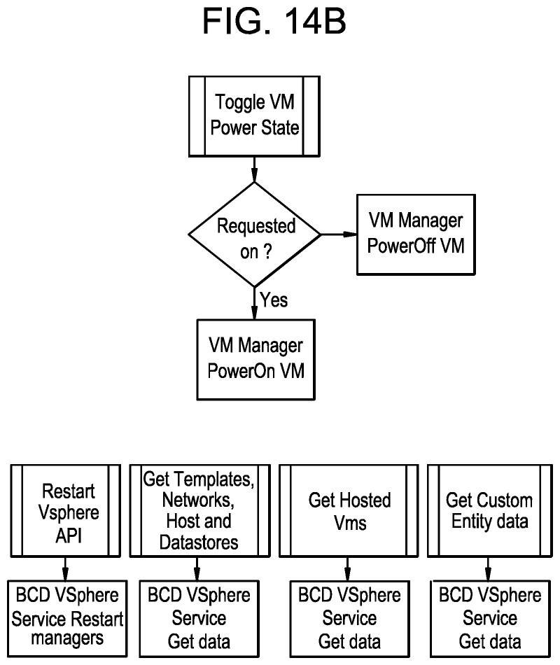

FIGS. 13A-13Z and 13AA-13ZZ collectively show that when the plugin starts and is logged in, the plugin initializes by attempting to establish a connection to the VSphere instance. If successful, the system creates and instantiates the plugin managers and begins monitoring the VSphere instance for data. The service can also reset the API connection if a new configuration is persisted.

FIGS. 14A and 14B collectively show how the request handlers handle the following request commands from the client application: create/update a virtual machine; toggle the VM power state; restart the VSphere API, retrieve VM data points (i.e., templates, networks, hosts, datastores), get VMs on the host machines, and get custom Entity Data.

The plugin is unique in that it opens doors and makes the virtual infrastructure management system accessible to non-technical people, specifically by providing a user-friendly user interface that is not overly complicated.

Before the present invention, typical response initiated with the local IT administrator monitoring and receiving information from the virtual infrastructure monitoring system. This is assuming that the administrator is on staff and available. When received, the IT admin must follow their processes and procedures to get that information to operations who then in turn begin another set of processes and procedures. The plugin disclosed herein simplifies this series of interactions.

In short, security Integrators can offer more value at less cost by implementing the plugin disclosed herein.

The plugin results in virtual machine monitor (such as VMware) working seamlessly with a security system (such as the Genetec Security Center suite). This allows for an entire network resolution from one familiar interface. As a result, the security staff no longer needs to learn how to access the complex virtual machine management system via an out-of-band management interface. By simplifying its functionality, the security staff can easily simultaneously monitor the virtual machine monitor and the security system via a single, easy to use interface. The Security Center interface allows the security guard to receive live, onscreen alerts about the status and state of the virtual machines.

In the above description, VMware, VSphere and Genetec are all trademarks of their respective owners. The trademarks are being used merely to describe one example of how the present invention could be configured and implemented, but other configurations and implementations are entirety possible (with completely different systems) while still staying very much within the scope of the present invention.

While a specific embodiment of the invention has been shown and described, it is envisioned that those skilled in the art may devise various modifications without departing from the spirit and scope of the present invention.

What is claimed is:

1. A system comprising: security system hardware; virtual machine monitoring hardware; a combined system connected to the security system hardware and virtual machine monitoring hardware and configured to provide a user interface that displays information relating to both the security system hardware and virtual machine monitoring hardware.

2. The system as recited in claim 1, wherein the security system hardware comprises access hardware and the virtual machine monitoring hardware is configured to monitor the access hardware.

3. The system as recited in claim 2, wherein the access hardware comprises identification scanners.

4. The system as recited in claim 1, wherein the security system hardware comprises video hardware and the virtual machine monitoring hardware is configured to monitor the video hardware.

5. The system as recited in claim 1, wherein the virtual machine monitoring hardware that is configured to monitor the security system hardware.

6. The system as recited in claim 5, wherein the security system hardware comprises a door sensor and the virtual machine monitoring hardware is configured to monitor the door sensor.

7. The system as recited in claim 5, wherein the security system hardware comprises a license plate scanner and the virtual machine monitoring hardware is configured to monitor the license plate scanner.

8. The system as recited in claim 1, wherein the combined system comprises a plugin with regard to the security system hardware.

9. The system as recited in claim 1, wherein the combined system provides the user interface which is configured to display information related to all connected hardware, wherein the system provides a combined security and virtual server management system, presented via the user interface.

10. The system as recited in claim 1, wherein the user interface is configured to allow a user to take action with regard to one or more items being monitored by the system.

11. The system as recited in claim 1, wherein the user interface is configured to allow a user to selectively hide and show data relating to both the security system hardware and the virtual machine monitoring hardware.

12. A plugin comprising software which causes a combined system to receive information from security system hardware and virtual machine monitoring hardware and display information on a user interface relating to both the security system hardware and virtual machine monitoring hardware.

13. The plugin as recited in claim 12, wherein the security system hardware comprises access hardware and the virtual machine monitoring hardware is configured to monitor the access hardware.

14. The plugin as recited in claim 12, wherein the security system hardware comprises video hardware wherein the security system hardware comprises video hardware and the virtual machine monitoring hardware is configured to monitor the video hardware.

15. The plugin as recited in claim 12, wherein the plugin allows a user to take action with regard to one or more items being monitored by the system.

16. The plugin as recited in claim 12, wherein the plugin allows a user to selectively hide and show data relating to both the security system hardware and the virtual machine monitoring hardware.
